(19) United States
(12) Patent Application Publication
(10) Pub. No.: US 2006/0283920 A1
(43) Pub. Date: Dec. 21, 2006

(54) Vibration stress relief of superalloy components

(75) Inventor: John Chitty, Hamilton (CA)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/156,320

(22) Filed: Jun. 17, 2005

(51) Int. Cl. B23K 31/02

(52) U.S. Cl. 228/203

(57) ABSTRACT

A method of conditioning and stress relief for superalloy components includes vibrating the component during welding at a subharmonic frequency. The proper frequency is selected to be below a harmonic frequency, and to produce an amplitude in the range of ⅓ to ½ the amplitude produced by a harmonic frequency. The component to be repaired is vibrated during and after welding at this frequency.

### BACKGROUND OF THE INVENTION

1. Field of the Invention

The present invention relates to stress reduction during welding. More specifically, the invention provides a method of weld conditioning and stress relief wherein the component being welded is vibrated during welding to reduce stresses in the component.

2. Description of the Related Art

Welding is typically used to perform repairs on components of various equipment that is subject to harsh environments. One example is the repair of blades for combustion turbines by gas tungsten arc welding (GTAW) or plasma arc welding (PAW) welding. Such blades are subject to high temperature and high stresses during operation of the turbine.

Combustion turbine blades are typically made from superalloys, which are defined herein as nickel based alloys containing aluminum and/or titanium as precipitation hardening elements, or cobalt based alloys. These components are often made by casting, after which they are typically subjected to various heat treatments, for example, homogenization, hot isostatic pressing, solutionizing, and/or aging. The heating rate, hold temperature, hold time, and cooling rate of these heat treatment processes are intended to produce optimally sized and shaped grains of precipitate of Ni₃(Al,Ti) and carbides within the material. The volume percentage, size, and distribution of these precipitates, along with the type and distribution of the carbide, determine the mechanical properties of the material. An optimum volume percentage and distribution of precipitates is the source of the material's high temperature strength.

As a result of the importance of grain structure and distribution in strengthening these materials, these alloys are particularly difficult to weld and to heat treat due to the effect of such procedures on the grain structure of the material. Combustion turbine blades made from superalloys are presently repaired in the solution treated condition either at elevated temperatures using high-strength filler materials, or at room temperature using high ductility filler materials. The repaired blade is then subjected to a solution heat treatment. If stresses are present as a result of the welding process, cracking may occur either on cooling following welding and/or during the post weld solution heat treatment. Therefore, reduction of weld stresses prior to solution heat treating is important. It would be desirable to perform welding at room temperature to reduce the time, ease, and cost required to perform the welding.

The use of vibrating a component being welded to reduce stress has been used for aluminum components in the past. However, vibration stress relief has not previously been used for superalloy components, in part because appropriate vibration frequencies have not been developed.

Accordingly, there is a need for a method of relieving stress within a superalloy component such as a turbine blade during weld repairs, ensuring that stresses are reduced prior to solution heat treatment. There is a further need for the development of appropriate frequencies for using vibration stress relief upon components made from superalloys.

### SUMMARY OF THE INVENTION

The present invention provides a method of stress relief for superalloy components such as the blades used within combustion turbines. The method includes the step of vibrating the component being repaired during the welding process.

Initially, the optimal frequency is determined by running a frequency test covering the spectrum of 0 Hz to at least about 105 Hz or possibly a greater frequency. The harmonic frequencies will be determined by looking for the frequencies that produce the highest amplitude vibrations. When the second such harmonic frequency is discovered, a frequency that is lower than the harmonic frequency, and which produces an amplitude in the range of ⅓ to ½ the amplitude produced by the harmonic frequency, is selected. Such a frequency will produce sufficient vibration to effectively reduce stresses in the substrate, without producing sufficient vibration to risk damaging the substrate. Welding is performed with the component being vibrated at this frequency. Upon completion of welding, the vibrating will continue throughout the cool down cycle, and should ideally be continued until the component is warm to the touch.

Accordingly, it is an object of the present invention to provide a method of conditioning and relieving stress during welding.

It is another object of the invention to provide a method of determining an ideal frequency for relieving stress within superalloy components during welding.

These and other objects of the invention will become more apparent through the following description and drawings.

### BRIEF DESCRIPTION OF THE DRAWINGS

FIG. 1 is an environmental, isometric view of an apparatus for vibration stress relief during welding for use with the method according to the present invention.

FIG. 2 is an isometric view of a fixture for holding a turbine blade during vibration stress relief according to the present invention.

FIG. 3 is an isometric top view of an apparatus for performing vibration stress relief according to the present invention.

FIG. 4 is a graph showing the results of a test to determine the proper frequency at which to perform vibration stress relief.

Like reference characters denote like elements throughout the drawings.

### DETAILED DESCRIPTION

The present invention provides a method of stress relief for superalloy components, for example, the blades of a combustion turbine.

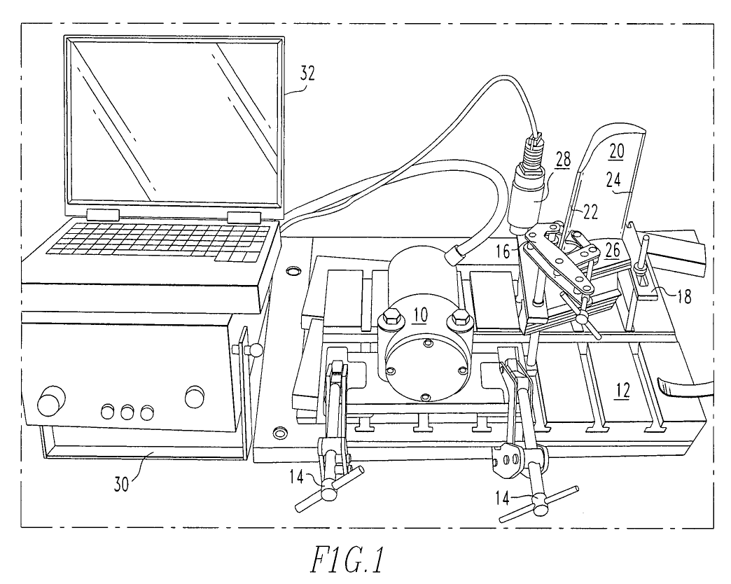

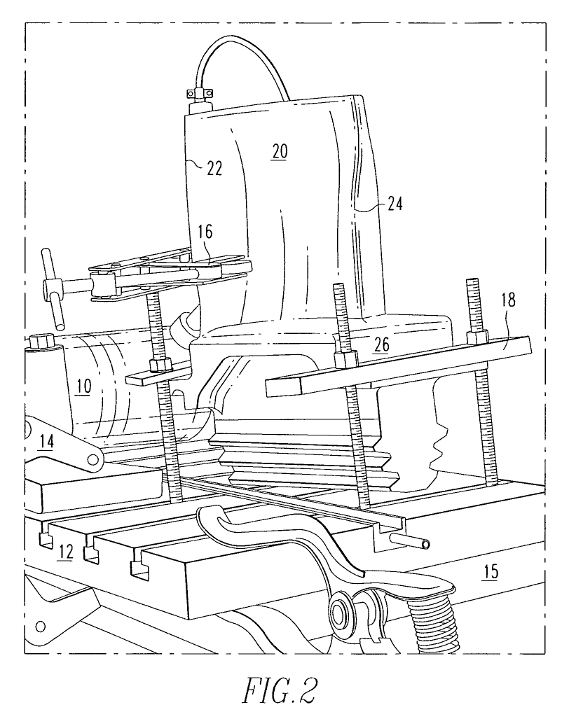

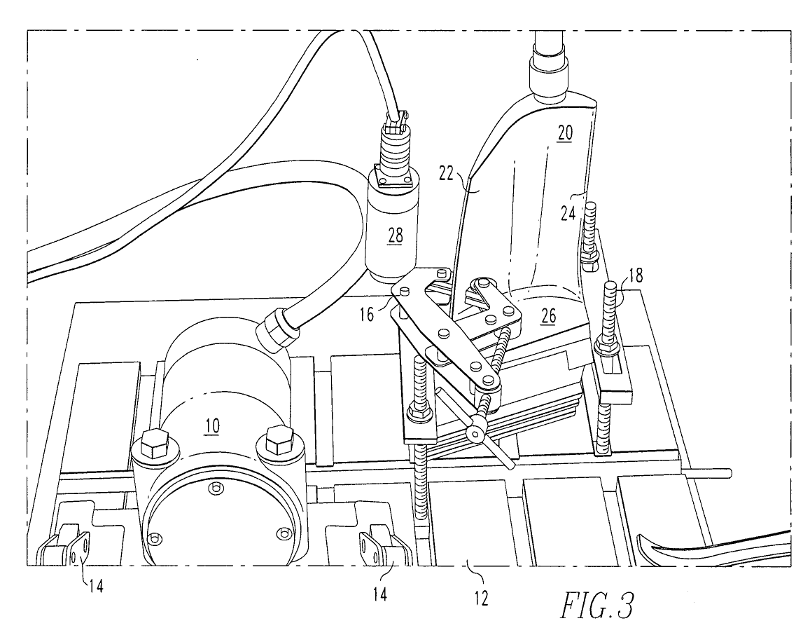

An apparatus for performing vibration stress relief is illustrated in FIGS. 1-3. The apparatus includes a preferred force inducer 10 for the illustrated example using a blade weighing about 12-20 lbs. should be capable of applying up to 190 lbs. of force. One example of a preferred force inducer is a Meta-Lax Model V8 force inducer. Meta-Lax equipment is available from Bonal Technologies, Inc., located in Royal Oak, Mich. The force inducer 10 is clamped to a bedplate 12 by the clamps 14. Although not shown on the drawing, it is well understood by those skilled in the art of welding that the force inducer 10 must be electrically insulated from the bedplate 12 by appropriate insulating materials therebetween. Additionally, the bedplate 12 is atop an elastomeric, electrically insulating pad 15, for example, a rubber pad that may have a thickness of about one inch, to ensure that only the bed plate and items secured thereon are vibrated, without substantial interference with the vibrations from the surrounding environment, and so that electrical arc welding procedures may be performed without current flowing in undesired locations. One or more clamps 16, 18 are provided to secure the component being welded to the bedplate 12. In the illustrated example, the component being welded is the turbine blade 20, with the clamp 16 being structured to secure the leading edge 22 of the turbine blade 20, and the clamp 18 being structured to be positioned behind the trailing edge 24, securing the base 26 to the bedplate 12.

A transducer 28 is structured to be secured to the bedplate 12, where it can measure the vibrations generated by the force inducer 10. A preferred transducer 28 is a Meta-Lax Model 99-7 transducer. The transducer 28 is preferably secured within three feet of the force inducer 10. Both the force inducer 10 and transducer 28 are electrically connected to a consol 30, which is itself electrically connected to a computer 32 having appropriate software to control the action of the force inducer 10 in response to input from the transducer 28, along with the weight of the component 20 and other information related to the component 20. An example of a suitable consol is a Meta-Lax Model 2700-CC Consol, and an example of suitable software is the 2700-CC Meta-Lax program software.

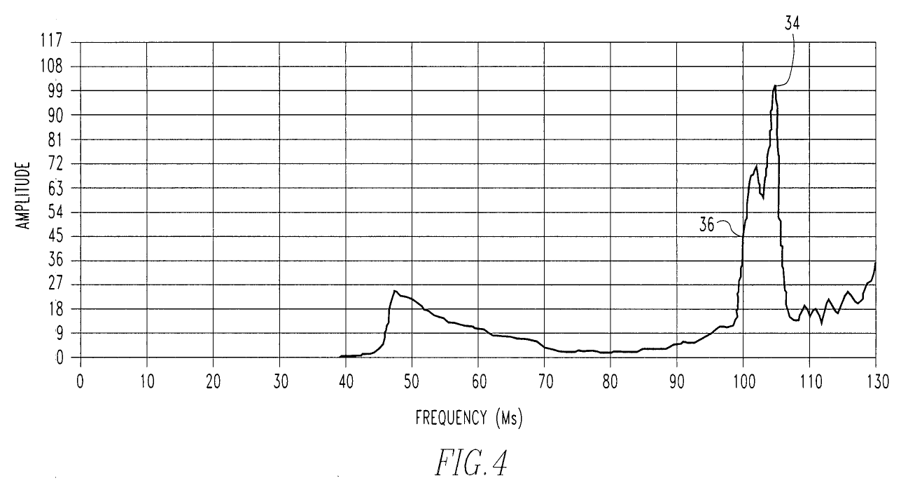

In use, an appropriate vibrating frequency for the component 20 is first determined. Such a frequency is typically about 100 Hz although the test spectrum is preferably from 0 Hz to about 120 Hz. As each frequency is tested, the resulting vibrational amplitude is recorded. Preferably, the test should be completed within 30 seconds. The harmonic frequencies can be determined by examining the amplitudes produced by the various frequencies, with the frequencies producing the greatest amplitudes being the harmonic frequencies. If various frequencies are tested in order of increasing frequency and more than one harmonic frequency is discovered, then the second harmonic frequency discovered will be used as the originating point for determining the appropriate vibrational frequency. Referring to FIG. 4, a harmonic frequency 34 is illustrated, with the harmonic frequency 34 being 104.6 Hz, resulting in an amplitude of 100. The selected vibrational frequency should be lower than the selected harmonic frequency, and produce an amplitude between ⅓ and ½ the amplitude produced by the selected harmonic frequency. The resulting subharmonic frequency 36 selected for vibration stress relief is 100 Hz, producing an amplitude of 45.

Upon determination of the proper frequency, the force inducer 10 is used to induce vibrations within the bedplate 12, and therefore within the component 20, at the selected frequency for the duration of the welding process. The amplitude of the vibrations is kept sufficiently small to resist any effect on the accuracy of the welding.

Upon completion of the welding, the force inducer 10 is again used to vibrate the bedplate 12 and component 20 while the weld cools. Preferably, the vibration continues until the welded components have cooled to the point where they are warm to the touch. At this point, the component 20 may be removed from the clamp 16, 18, and inspected for any dimensional distortion.

The present invention therefore provides a method of relieving stress within superalloys during welding, thereby reducing the risk of cracking on cooling following welding and during the subsequent heat treatment of the superalloy component. The method further provides a method of determining an ideal frequency for the vibrational stress relief for use while welding turbine blades and other components made from superalloys.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of reducing stresses within a superalloy substrate during welding, the method comprising:
identifying a harmonic frequency of the substrate;
selecting a frequency that produces an amplitude of about ⅓ to ½ an amplitude produced by the harmonic frequency, and which is a lower frequency than the harmonic frequency;
vibrating the substrate at the selected frequency while welding the substrate.

2. The method according to claim 1, further comprising vibrating the substrate at the selected frequency as the substrate cools after welding.

3. The method according to claim 1, further comprising vibrating the substrate with a force having a ratio to substrate weight of about 9:1 to about 16:1.

4. The method according to claim 1, wherein the frequency selected is between about 0 Hz. and about 120 Hz.

5. The method according to claim 1, further comprising:
testing various frequencies beginning with a lower frequency and progressing towards higher frequencies;
identifying the second harmonic frequency encountered during testing; and
selecting a frequency that produces an amplitude of about ⅓ to ½ an amplitude produced by the second harmonic frequency, and which is a lower frequency than the second harmonic frequency.

6. The method according to claim 5, further comprising vibrating the substrate at the selected frequency as the substrate cools after welding.

7. The method according to claim 5, further comprising vibrating the substrate with a force having a ratio to substrate weight of about 9:1 to about 16:1.

8. The method according to claim 5, wherein the frequency selected is between about 0 Hz. and about 120 Hz.
